(19) United States
(12) Patent Application Publication
(10) Pub. No.: US 2025/0363489 A1
(43) Pub. Date: Nov. 27, 2025

(54) METHOD AND SYSTEM FOR AUDITABLE OFF-CHAIN TRANSACTION IN BLOCK-CHAIN NETWORK

(71) Applicant: Jinan University, Guangzhou (CN)

(72) Inventors: Ming LI, Guangzhou (CN); Haonan SUN, Guangzhou (CN); Jian WENG, Guangzhou (CN); Yuxian LI, Guangzhou (CN); Jiasi WENG, Guangzhou (CN); Junzuo LAI, Guangzhou (CN)

(21) Appl. No.: 19/294,174

(22) Filed: Aug. 7, 2025

(51) Int. Cl. G06Q 20/38; G06Q 20/40; H04L 9/30

(52) U.S. Cl. CPC G06Q 20/389; G06Q 20/3827; G06Q 20/3829; G06Q 20/407; H04L 9/3006

(57) ABSTRACT

A method for auditable off-chain transaction in block-chain network includes: defining counterparties, auditors and their responsibilities; creating an off-chain payment channel between the counterparties and initializing the off-chain payment channel by both of the counterparties; updating channel status during each transaction process; and initiating an audit process to verify an integrity of a history of the off-chain transaction after the off-chain payment channel is closed; wherein a hash chain linking current and previous transactions of the off-chain payment channel in a chronological order is established during the transaction processes, and an Accountable Assertions with Flexible Public Key (AAFPK) mechanism is used to bind fund and commitment information generated by counterparties to a flexible public key through assertions, the hash chain is submitted to auditors for verifying when off-chain payment channel is closed, and AAFPK mechanism binds inconsistencies or differences of the off-chain transaction to a responsible party.

### TECHNICAL FIELD

The present disclosure relates to the field of blockchain payment channels, particularly to a method and system for designing a secure and auditable off-chain transaction framework with flexible accountability mechanisms.

### BACKGROUND

The increasing popularity of blockchain-based payment channels has significantly improved the scalability and efficiency of blockchain systems by enabling off-chain transactions. These channels allow participants to execute multiple transactions without committing each one to the blockchain, thereby reducing the transaction costs and improving throughput. Payment channels rely on mechanisms such as state updates and commitment transactions to securely handle transactions between parties. With the proliferation of decentralized finance (DeFi) and cryptocurrency usage, payment channels have become a critical tool for achieving scalability in blockchain networks.

However, the reliance on off-chain transactions also introduces several challenges and vulnerabilities. One significant issue is the potential for malicious behavior by participants, such as withholding information, double-spending, or creating conflicting transactions. Moreover, ensuring the integrity and auditability of off-chain transactions becomes a crucial concern, as disputes or dishonest behavior can undermine trust in payment channels. For instance, one participant might deliberately tamper with the transaction history or provide conflicting updates to deceive the counterparty or auditors. These actions threaten off-chain payment systems' transparency, accountability, and security.

Another major challenge lies in the privacy and confidentiality of off-chain transactions. While off-chain mechanisms reduce the on-chain visibility of individual transactions, ensuring that sensitive information, such as transaction amounts or user identities, is protected without compromising the system's accountability is non-trivial. Additionally, the need for a trusted third party to resolve disputes or verify transaction history raises concerns about centralization, privacy leakage, and abuse of power.

Although several blockchain-based payment channel schemes have been proposed to address these issues, many of them focus on resolving specific challenges, such as transaction efficiency or dispute resolution, without providing comprehensive solutions for privacy, accountability, and security in off-chain transactions. Furthermore, existing frameworks often lack mechanisms to handle scenarios where dishonest participants attempt to tamper with transaction records or generate conflicting claims, and they may not adequately preserve the privacy of sensitive transaction details.

### SUMMARY

To address these issues, the present disclosure proposes a method for auditable off-chain transaction in block-chain network, comprising:
defining participants and their responsibilities, wherein the participants include counterparties requiring an off-chain transaction and auditors that audit transaction information of the off-chain transaction;
creating an off-chain payment channel for carrying out the off-chain transaction between the counterparties and initializing the off-chain payment channel by both of the counterparties;
after creating the off-chain payment channel, updating channel status during each transaction process; and
initiating an audit process to verify an integrity of a history of the off-chain transaction happened on the off-chain payment channel after the off-chain payment channel is closed;
wherein a hash chain linking current and previous transactions of the off-chain payment channel in a chronological order is established during the transaction processes, and an Accountable Assertions with Flexible Public Key (AAFPK) mechanism is used to bind fund and commitment information generated by both of the counterparties to a flexible public key through assertions, the hash chain is submitted to the auditors for verifying an order and a consistency of the off-chain transaction of the off-chain payment channel when the off-chain payment channel is closed, and the AAFPK mechanism binds any inconsistencies or differences of the off-chain transaction to a responsible party.

In some embodiments of the present disclosure, the following technical solutions may be used in the implementations of the present disclosure.

Audit Model: the audit model formally defines the participants (including counterparties and auditors) and their responsibilities, ensuring the integrity of transactions, accuracy of order, and consistency of income/expenses. Audit operations include creating, updating, closing, punishing, and auditing payment channels.

Accountable Assertions with Flexible Public Key (AAFPK): This mechanism ensures that participants who make contradictory statements in the same context are punished, thereby achieving non-repudiation.

Using a hash chain mechanism for off-chain transactions, linking transactions together using a hash chain to ensure the order and integrity of transactions.

Both parties of the transaction initialize the payment channel by setting initial funds and submitting the transaction, and use AAFPK to bind the fund commitment information to a flexible public key through assertions. Based on these contents, the hash value is calculated as the first hash value of the hash chain.

After creating the initial payment channel, both parties update the channel status during the transaction process. Each update records the new balance situation of both parties and assigns a new key pair. Based on the current latest status and the hash value of the previous transaction, a new hash value is calculated and linked to the previous transaction.

After the channel is closed, initiate the audit process to verify the integrity of the off-chain transaction history. Hash chains are used to submit to auditors for verifying the order and consistency of transactions, ensuring that the update process has not been tampered with; AAFPK provides an accountability mechanism that binds any inconsistencies or differences to the responsible party.

The auditing party verifies the correctness of the hash chain. If dishonest behavior is detected during the audit process (such as publishing revoked transactions or tampering with transaction history), the responsible party will be punished.

According to some embodiments, the present disclosure proposes an enhanced payment channel framework named IvyAPC, which introduces secure protocols for transaction accountability and privacy preservation. The proposed framework ensures that off-chain transactions are both auditable and confidential while providing mechanisms to detect and mitigate malicious behavior. By leveraging cryptographic techniques, such as flexible public key systems and chain-linking methods, IvyAPC achieves fine-grained access control, secure transaction verification, and robust dispute resolution, thereby enhancing the overall security and efficiency of blockchain-based payment channels.

The IvyAPC is a universal auditable payment channel protocol that can address the problem of off-chain transaction auditing in payment channels (PCs). This protocol adopts core cryptographic mechanisms such as accountable assertions with flexible public keys (AAFPK) and hash chains to ensure transparency, accountability, and security. The operation of payment channels is divided into detailed stages, in which specific technologies are applied to achieve their functions and ensure logical continuity and complete processes between each stage.

### BRIEF DESCRIPTION OF THE DRAWINGS

The drawings described here are intended to provide a further understanding of the present disclosure, and constitute a part of the present disclosure. The illustrative implementations of the present disclosure and description of the implementations are intended to describe the present disclosure, and do not constitute limitations on the present disclosure.

FIG. 1 is an illustration of on-chain timestamp witnessing.

FIG. 2 is an illustration of the IvyAPC protocol.

### DETAILED DESCRIPTION OF THE EMBODIMENTS

The exemplary embodiments of the present disclosure are described below in detail with reference to the drawings. It should be understood that the exemplary embodiments described below are used only to illustrate and interpret the present disclosure and are not intended to limit the present disclosure.

It should be noted that the exemplary embodiments of the present disclosure and features in the exemplary embodiments may be combined with each other in the case of no conflict, and all the combinations fall within the protection scope of the present disclosure. In addition, although a logical order is shown in the flowchart, the steps shown or described may be performed in a different order from the order here in some cases.

According to one embodiment of the present disclosure, a method for auditable off-chain transaction in block-chain network basically comprises the following steps:
defining participants and their responsibilities, wherein the participants include counterparties requiring an off-chain transaction and auditors that audit transaction information of the off-chain transaction;
creating an off-chain payment channel for carrying out the off-chain transaction between the counterparties and initializing the off-chain payment channel by both of the counterparties;
after creating the off-chain payment channel, updating channel status during each transaction process; and
initiating an audit process to verify an integrity of a history of the off-chain transaction happened on the off-chain payment channel after the off-chain payment channel is closed.

Further, a hash chain linking current and previous transactions of the off-chain payment channel in a chronological order is established during the transaction processes, and an Accountable Assertions with Flexible Public Key (AAFPK) mechanism is used to bind fund and commitment information generated by both of the counterparties to a flexible public key through assertions, the hash chain is submitted to the auditors for verifying an order and a consistency of the off-chain transaction of the off-chain payment channel when the off-chain payment channel is closed, and the AAFPK mechanism binds any inconsistencies or differences of the off-chain transaction to a responsible party.

In a preferable implementation, the method further comprises a step of triggering a punishment mechanism if a dishonest behavior is detected during the audit process, wherein the dishonest behavior includes publishing revoked transactions or tampering with transaction history or making contradictory statement.

In a preferable implementation, the punishment mechanism comprises allowing the counterparty to obtain a deposit of a malicious party who fails to publish the transaction correctly.

In a preferable implementation, the step of creating an off-chain payment channel and initializing the off-chain payment channel by both of the counterparties by setting initial funds and submitting a transaction further comprises locally creating a funding transaction and a commitment transaction by both of the counterparties; wherein the off-chain payment channel is successfully established when the funding transaction is published on the block-chain network, and the off-chain payment channel is ultimately closed when any commitment transaction is published to the block-chain network.

In a preferable implementation, the establishment of the hash chain comprises: after the off-chain payment channel is initialized and the fund and commitment information is bound to the flexible public key through assertions, calculating a hash value accordingly as a first hash value of the hash chain; and after each update of the channel status, calculating a new hash value based on a current latest channel status and the harsh value of the previous transaction, and the new hash value is linked to the previous transaction.

In a preferable implementation, the establishment of the hash chain comprises: incorporating a timestamp of an on-chain transaction to accurately mark a timing of a commitment transaction created on the off-chain payment channel and to establish a correlation with the chronological order of on-chain transactions.

In a preferable implementation, the hash chain is established by Extractable Chameleon Hash with Flexible Public Key (ECHFPK), where a public key or secret key is transformable into a new representative of the same equivalence class, namely, the pair of old and new key are related through a hard relation R.

In a preferable implementation, the AAFPK mechanism generates a key pair including a public key and a secret key, the key pair is transformable into a different representative key pair, and the AAFPK mechanism allows both of the counterparties to make multiple statements in the same context under different representative secret keys without exposing the secret key.

In order to facilitate understanding of the present disclosure, an enhanced payment channel framework named IvyAPC protocol is specifically described below as an exemplary implementation/embodiment of the present disclosure, the IvyAPC protocol incorporates some specific technical means including on-chain timestamp witnessing, Extractable Chameleon Hash with Flexible Public Key (ECHFPK), Accountable Assertions with Flexible Public Key (AAFPK), and the constructions and/or algorithms for implementing these technical means are described below. Also, an exemplary construction of the IvyAPC protocol is also introduced below. However, it should be noted that the present disclosure is not necessarily limited to the disclosed scheme, the concept or core idea may be realized by equivalent substitution of some parts or steps of the whole scheme.

### On-chain Timestamp Witnessing

Generally, the timestamp of an on-chain transaction is set as when it is sent into the transaction pool. In PCs, only the final commitment transaction will be sent to the transaction pool; hence, most commitment transactions do not have a timestamp. However, it is problematic to have the trading party set a timestamp for the promised transaction on the PCs, since they can set it arbitrarily for their benefit, breaking the basic audit requirement that demands transactions to attach a relatively accurate timestamp. Therefore, an on chain timestamp witnessing method is introduced in the protocol of this present disclosure, enabling auditors to check the timestamps of committed transactions.

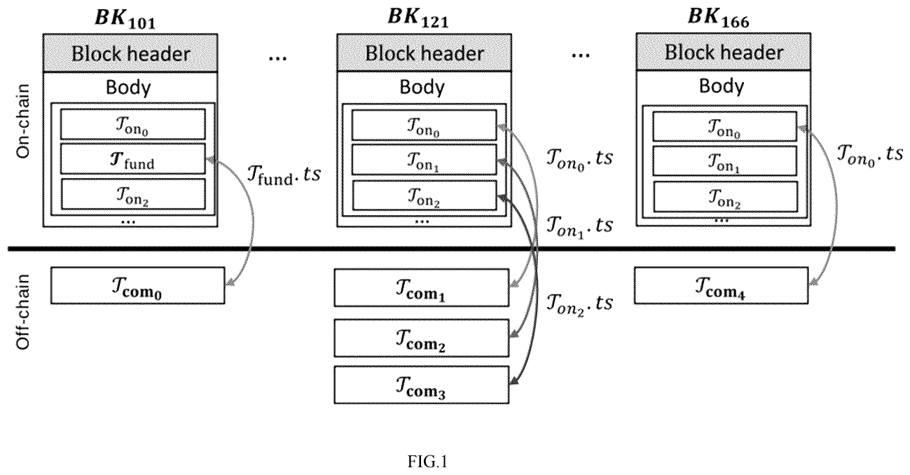

The illustration of on-chain timestamp witnessing is referenced in FIG. 1. As shown in the picture, all on-chain transactions contained in the blockchain will be sorted by timestamp. Suppose that the latest block is BK₁₂₁ when the later commitment transaction [symbol] _{com}_{₁} is generating. Party A chooses the earliest timestamp of on-chain transaction, i.e., [symbol] ₒₙ_{₀}.ts, as a reference to set the timestamp of [symbol] _{com}_{₁}. If both parties generate multiple committed transactions within the same block, i.e., [symbol] _{com}_{₂} and [symbol] _{com}_{₃}, then a set of consecutive earliest timestamps can be referenced, i.e., [symbol] ₒₙ_{₁}.ts and [symbol] ₒₙ_{₂}.ts.

Through timestamps, off-chain transactions can establish a clear correlation with the chronological order of on-chain transactions, providing strong evidence for auditing and verification.

### IvyAPC Protocol

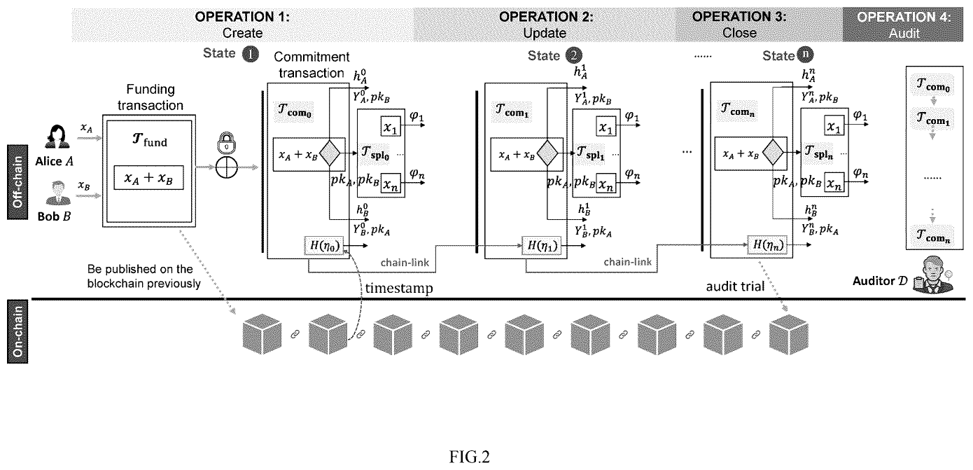

In the present disclosure, the IvyAPC protocol is used to implement audit functionality under payment channels. The illustration of the IvyAPC protocol is referenced in FIG. 2.

Firstly, introduce the cryptographic algorithms used in this protocols:

### Cryptography Algorithms

In the present disclosure, the following cryptographic algorithms are used as building blocks to implement accountability and auditing functions.

### Extractable Chameleon Hash With Flexible Public Key (ECHFPK)

ECHFPK is a randomized hash function that can easily compute collisions given a trapdoor and allows anyone to extract the trapdoor given two different messages and random number pairs. Compared with conventional extractable chameleon hash, we extend it with the flexible public key (called ECHFPK), where a public key or secret key can be transformed into a new representative of the same equivalence class, i.e., the pair of old and new key are related through a hard relation R. Generally, ECHFPK consists of the following six Probabilistic Polynomial Time (PPT) algorithms:

(cpk, csk)←Gench(1^{λ}): The setup algorithm takes a security parameter λ as the input and outputs a public key cpk and a secret key csk.

h←Ch(cpk, x; r): the evaluation algorithm generates a hash value h with the public key cpk, a message x, and a random r.

cpk′←ChgChCPK(cpk, ω): the public key transformation algorithm takes cpk of an equivalence class [cpk]_{R} and a public parameter ω as inputs. It outputs a different representative public key cpk′, where cpk′∈[cpk]_{R}.

csk′←ChgChCSK(csk, ω): the secret key transformation algorithm takes a trapdoor csk and public parameter ω as inputs, and outputs a different representative secret key csk′. This algorithm is reversible that given csk′, it allows anyone to recover the secret key csk with the public ω.

r₁←Col(csk′, x₀, r₀, x₁): the collision-finding algorithm takes a trapdoor csk′ and a triple x₀, r₀, x₁ as inputs, and outputs a value r₁ such that Ch(cpk′, x₀; r₀)=Ch(cpk′, x₁; r₁).

csk′←ExtractCsk(cpk′, (x₀, r₀, x₁, r₁): the extraction algorithm takes a public key cpk′ and a 4-tuple (x₀, r₀, x₁, r₁) as inputs, and outputs csk′.

Specifically, the extractable chameleon hash function satisfies the following three attributes:
collision-resistance: A PPT adversary A to find a collision without a trapdoor is negligible.
uniformity: Given two messages x₀ and x₁, for a uniformly random value r₀, the output of Col is also a uniformly distributed random value.
extractability: Given two pairs (x₀, r₀) and (x₁, r₁), where Ch(cpk′, x₀; r₀)=Ch(cpk′, x₁; r₁) and x₀≠x₁, the trapdoor csk′ can be extracted. The public and secret key transformation algorithms are instantiated according to the instantiation of extractable chameleon hash.

### Accountable Assertions With Flexible Public Key (AAFPK)

AAFPK allows parties to make multiple statements in the same context under different representative secret keys without exposing the secret key. It's core idea is based on ECHFPK supporting that a key pair (apk, ask) can be transformed into a different representative key pair (apk′, ask′). The AAFPK protocol is a tuple of PPT algorithms \tilde{Σ}:=(Gen, Assert, Verify, ChgAPK, ChgASK, Extract):

(apk, ask, auxsk)←Gen(1^{λ}): The key generation algorithm inputs a security parameter λ, and outputs a public key apk, a secret key ask, an auxiliary secret information auxsk. For each public key, there is exactly one secret key.

ask′←ChgASK(ask, ω): The secret key transformation algorithm takes a representative secret key ask, and a public parameter ω as inputs, and outputs a different representative secret key ask′. The algorithm is reversible in that given ask′, it allows anyone to recover the secret key ask with the public ω.

apk′←ChgAPK(apk, ω): The public key transformation algorithm inputs a representative public key apk of equivalence class [apk]_{R}, and a public parameter ω, and outputs a different representative public key apk′∈[apk]_{R}.

τ/⊥←Assert(ask′, auxsk, ct, st): The assertion algorithm takes a secret key ask′, an auxiliary secret information auxsk, a context ct, a statement st as inputs. It outputs an assertion τ (or ⊥ if the algorithm fails to execute).

1/0 ←Verify(apk′, ct, st, τ): The verification algorithm takes a public key apk′, a context ct, a statement st and an assertion τ as inputs, and outputs 1 if τ is a valid assertion.

ask′/⊥←Extract(apk′, ct, st₀, st₁, τ₀, τ₁): The extraction algorithm inputs a public key apk′, a context ct, two statements st₀, st₁, two assertions τ₀, τ₁, and outputs either ask′ or ⊥ to indicate failure.

### AAFPK Construction

This is the detailed construction of AAFPK.

Key Generation: The key generation algorithm chooses L be a hash function: {0, 1}*→{1, . . . , [symbol] }, m and [symbol] are two positive integers that represent the branching and height of a tree. L(·) is modeled as a random oracle. H₀, H₂ be hash functions which are modeled as random oracles, H₁ be a collision-resistant hash function, and PRF be a pseudo-random function. Then, generate the secret key ask:=csk, auxiliary secret information auxsk:=κ, where (cpk, csk)→ECHFPK.GenCh(1^{λ}), κ∈{0, 1}^{λ} is a key for the PRF. It sets the public key as apk:=(cpk, z, L, H₀, H₁, H₂), where

$$z := {H}_{0} ( {y}_{1}^{1} , … , {y}_{m}^{1} ) , {y}_{i}^{1} := Ch ( {PRF}_{κ} ( id , i , 0 ) ;$$

PRF_{κ}(id, i, 1)), i∈[m], and id is an identifier for the position of the root node.

Secret Key Transformation: In this algorithm, the secret key is represented as ask and initially set as csk. Then convert it into a new key ask′ using the ChgASK(ask, ω) function, ask′ and ask belong to the same equivalence class. This function effectively converts the secret key into another secret key within the same class, represented as ask′:=ECHFPK.ChgChCSK(csk, ω), and ω stands for a specific public parameter chosen for this operation. This transformation allows the original secret key ask, to be retrieved when given csk and ω.

Public Key Transformation: This algorithm changes the public key apk:=(cpk, z, L, H₀, H₁, H₂) into an updated public key apk′:=(cpk′, z), where cpk′:=ECHFPK.ChgChCPK(cpk, ω) and ω refers to a chosen public parameter. This transformation allows the original secret key ask, to be retrieved when given csk and ω.

Assertion: The assertion algorithm takes (ask′, auxsk, ct, st) as inputs. Then computes the assertion path { [symbol] , [symbol] , . . . , Y₁, a₁} from the leaf node [symbol] to the root node Y₁, [symbol] stores the number L(ct) and each node Yⱼ contains m entries

$${Y}_{j} := {y}_{1}^{j} , … , {y}_{m}^{1} ,$$

j∈[m] at positions aⱼ∈1, . . . , m. To assert a statement st in the context ct which is stored in [symbol] , the assertion algorithm computes

$${r}_{{a}_{ℓ}}^{′ℓ} := Col ( {csk}^{′} , {x}_{{a}_{ℓ}}^{ℓ} , {H}_{1} ( st ) ) , ( {x}_{{a}_{ℓ}}^{ℓ} , {r}_{{a}_{ℓ}}^{ℓ} )$$

refer to the values that were set when the tree was initially generated. The calculation formula for the position of this entry is

$${r}_{{a}_{ℓ}}^{ℓ} = {H}_{2} ( Ch ( {cpk}^{′} , {H}_{1} ( st ) ; {r}_{{a}_{ℓ}}^{′ℓ} ) , {r}_{{a}_{ℓ}}^{′ℓ} ) = {H}_{2} ( Ch ( {cpk}^{′} , {x}_{{a}_{ℓ}}^{ℓ} ; {r}_{{a}_{ℓ}}^{ℓ} ) , {r}_{{a}_{ℓ}}^{′ℓ} ) .$$

Then the algorithm calculates other entries of [symbol] as:

$${y}_{i}^{ℓ} := Ch ( {cpk}^{′} , {x}_{i}^{ℓ} ; {r}_{i}^{′ℓ} ) ,$$

where i∈[m]\ [symbol] . It stores the entries

$$\{ {y}_{1}^{ℓ} , … , {y}_{m}^{ℓ} \}$$

to [symbol] , and lets

$${z}_{ℓ} := {H}_{0} ( {y}_{1}^{ℓ} , … , {y}_{m}^{ℓ} ) and {f}_{ℓ} := ( {y}_{1}^{ℓ} , … , {y}_{{a}_{ℓ - 1}}^{ℓ} , … , {y}_{m}^{ℓ} ) .$$

Similarly, the algorithm calculates other nodes ( [symbol] , [symbol] , . . . , Y₁, a₁) as in the computation of ( [symbol] , [symbol] ). With these information, the assertion

$$τ := ( ( {r}_{{a}_{ℓ}}^{′ℓ} , {f}_{ℓ} , {a}_{ℓ} ) , … , ( {r}_{1}^{′1} , {f}_{1} , {a}_{1} ) ) ,$$

where

$${f}_{ϵ} := ( {y}_{1}^{ϵ} , … , {y}_{{a}_{ℓ - 1}}^{ϵ} , {y}_{{a}_{ℓ + 1}}^{ϵ} , … , {y}_{m}^{ϵ} )$$

Verification: This algorithm takes (apk′, ct, st, τ) as inputs, and parses apk′ as (cpk′, z) and τ as

$$( ( {r}_{{a}_{ℓ}}^{′ℓ} , {f}_{ℓ} , {a}_{ℓ} ) , … , ( {r}_{1}^{′1} , {f}_{1} , {a}_{1} ) ) .$$

Then it reconstructs the path form the leaf node Yₗ to the root node Y₁, where

$${y}_{l} := ( {y}_{1}^{1} , … , {y}_{m}^{1} ) .$$

If the constructed root

$$H ( {y}_{1}^{1} , … , {y}_{m}^{1} )$$

is equal to z, it outputs 1; otherwise, it outputs 0.

Extraction: This algorithm takes (apk′, ct, st₀, st₁, τ₀, τ₁) as inputs and reconstructs the path from the leaf node to the root node for both (ct, st₀, τ₀) and (ct, st₁, τ₁). During the reconstruction, there will exist a node that forms a collusion in ECHFPK. That is, there exist values (x₀, r₀) and (x₁, r₁) that enables ECHFPK.Ch(cpk′, x₀; r₀)=ECHFPK.Ch(cpk′, x₁; r₁). According to the extraction algorithm of ECHFPK, the secret key cpk′ can be extracted as csk′←ECHFPK.ExtractCsk(cpk′, x₀, r₀, x₁, r₁). If no collusion is found, the extraction algorithm outputs ⊥.

### IvyAPC's Full Construction

The protocol specification defines a payment channel framework that supports audit functionality, combining on chain and off chain transaction mechanisms, with the aim of achieving efficient and accountable transactions. The protocol requires each extended payment channel γ contains at least one off chain transaction and be ultimately closed through transactions published on the chain. For ease of description, the complete transaction is modeled as two independent parts, symbolized by [symbol] :={[ [symbol] ], dat}. This protocol has the following processes:

Create: Creating a payment channel involves three key steps for the transacting parties, generating the funding transaction [symbol] _{fund}, creating the initial commitment transaction [symbol] _{com}_{₀}, and forming the initial split transaction [symbol] ₛₚₗ_{₀}. Compared to the GC protocol, this process differs in several key aspects: Assertion Exchange, Timestamping and Digest Inclusion.

Users A and B start by locally creating the funding transaction [ [symbol] _{fund}] and the commitment transaction [ [symbol] _{com}_{₀}]. To do this, A generates (apk_{A}, ask_{A}, auxsk_{A}) and B generates (apk_{B}, ask_{B}, auxsk_{B}), using function \tilde{Σ}.Gen with a security parameter λ, auxsk:=H₀(ask). The secret keys ask_{A} and ask_{B} are termed colluding secrets to ensure that any attempt by A and B to alter the history of off-chain transactions in γ can be penalized. Then A and B exchange their public keys, jointly build fund transactions this fund transactions contains public key pairs ξ₀=(apk _{A}, ask_{B}) and initial information of audit trail h₀=H₁ (ξ₀). These pieces of information are included in non consumable outputs, such as Bitcoin's OP-RETURN. And then each party generate their accountable assertions

$${τ}_{A}^{0} {τ}_{B}^{0} ,$$

where

$${τ}_{A}^{0} = \tilde{\sum } .$$

Assert (ask_{A}, auxsk_{A}, H₁ (0, [ [symbol] _{fund}], [ [symbol] _{com}_{₀}]), and similarly party B computes

$${τ}_{B}^{0} .$$

To ensure the validity of assertions, both parties exchange assertions and use the verification algorithm \tilde{Σ}. Verify to validate each other's assertions, if the verification is successful, A and B generate proof

$${ς}_{A}^{0} and {ς}_{B}^{0} .$$

This proof associates each party's private revocation key (r) with the other party's assertion (τ) using a hash function,

$${ς}_{A}^{0} = {H}_{0} ( {τ}_{B}^{0} ‖ {r}_{A}^{0} ) , {ς}_{B}^{0} = {H}_{0} ( {τ}_{A}^{0} ‖ {r}_{B}^{0} ) .$$

This mechanism also incorporates the timestamp of on-chain transactions to mark the commitment transactions' timing accurately. The audit trail from the first commitment transaction is captured in the format:

$${η}_{0} := ( {τ}_{A}^{0} , {τ}_{B}^{0} , {ς}_{A}^{0} , {ς}_{B}^{0} , [ {𝒯}_{fund} ] , [ {𝒯}_{{com}_{0}} ] , n ) ,$$

where

$${ς}_{A}^{0} := {H}_{0} ( {τ}_{B}^{0} ‖ {r}_{A}^{0} ) and {ς}_{B}^{0} := {H}_{0} ( {τ}_{A}^{0} ‖ {r}_{B}^{0} ) .$$

Once transacting parties generate the complete commitment transaction, they can exchange the (pre-)signature [symbol] ₛₚₗ_{₀}, [symbol] _{com}_{₀}, and [symbol] _{fund}, when [symbol] _{fund} is published on the blockchain, an auditable payment channel γ is successfully established.

Update: In this operation, transacting parties pay for each other by updating the state of the channel, they collaboratively update the state of γ from γ.cash:=(x_{A}, x_{B}) to γ. [symbol] :=( [symbol] , [symbol] ). This process involves several key steps: Invalidation of the Old Commitment Transaction and Generation of New Transactions. Each off-chain transaction [ [symbol] _{com}_{ₙ}] is constructed to distribute the total coins (x_{A}+x_{B}) in γ based on the latest agreed-upon balances. If either party releases [ [symbol] _{com}_{ₙ}] to the blockchain, the following conditions will be activated: (1) Colluding condition: (x_{A}+x_{B}) can be spent by a blockchain on-chain transaction that is verifiable w.r.t. X_{A} and X_{B} at any time after [ [symbol] _{com}_{ₙ}] was published on blockchains. If there are forged or unverified off chain transaction records, all funds in the channel can be used by the other party. (2) Publishing condition: (x_{A}+x_{B}) can be spent by either party with a time lock Δ if [ [symbol] _{com}_{ₙ}] was revoked. It allows funds to be used by both parties after the designated time lock Δ expires. (3) Finalizing condition: (x_{A}+x_{B}) is spent by A and B for finalizing the channel state of γ with a time lock 2Δ if [ [symbol] _{com}_{ₙ}] has not been revoked. Both parties collaborate to ultimately close the channel state, and the time lock of Δ is usually twice the release condition, used to provide a penalty time window.

More concretely, a participant (e.g., A) selects a public parameter ω_{A}∈Z_{q}* and modifies their secret key to

$${ask}_{A}^{n} := \sum \cdot ChASK ( {ask}_{A} , n \cdot {ω}_{A} ) := {ask}_{A} ⊕ n \cdot {ω}_{A} ,$$

the calculation method for public parameters is ω_{A}:=H₀( [symbol] _{fund}). When the n-th off-chain transaction is created in γ, users A and B exchange their accountable assertions

$${τ}_{A}^{n} , {τ}_{B}^{n} , where {τ}_{A}^{n} ← \tilde{\sum } \cdot Assert ( {ask}_{A} , {auxsk}_{A} , ct , {st}_{n} ) and {τ}_{B}^{n}$$

is the same. After exchange their accountable assertions, they embed the hash chain hₙ=Hash₁(hₙ₋₁∥ξₙ) in [ [symbol] _{com}_{ₙ}].
before committing it in γ. Upon receiving assertion

$${τ}_{A}^{n} ,$$

party B first computes a new representative public key

$${apk}_{A}^{n} = \tilde{\sum } \cdot ChAPK ( {apk}_{A} , n ⊙ {ω}_{A} ) := {apk}_{A} , n ⊙ {ω}_{A}$$

and then verifies

$${τ}_{A}^{n}$$

through using

$$\tilde{\sum } \cdot Verify ( {apk}_{A}^{n} , ct , {st}_{n} , {τ}_{A}^{n} ) .$$

If the verification is successful, B generates an audit certificate for A:

$${ς}_{B}^{0} := {H}_{0} ( {τ}_{A}^{0} ‖ {r}_{B}^{0} ) , {r}_{B}^{n}$$

is the revocation key of B. Then they record the audit trail ηₙ and generate as in Equation (1). The timestamp value is set to the earliest timestamp in the latest block. Finally, both parties sign a complete commitment transaction and split transaction.

Close: Transacting parties close the channel by publishing a commitment transaction to the blockchain. If one party fails to publish the transaction correctly, IvyAPC will punish the malicious party and allow the other party to obtain the malicious party's deposit.

Punish: This punishment mechanism is triggered in the following two situations: (i) Publish old commitment transactions. When A publishes a revoked old commitment transaction, the other party B can use the pre signature and full signature of the commitment transaction, and calculate A's secret witness [symbol] A through the extractability of the adapter signature. (ii) Redeclaration. When A generates two statements using the same representative private key, the other party B can use the key extraction algorithm \tilde{Σ}. Extract the secret private key ask_{A} of A.

Audit: This operation is performed by auditor [symbol] who requires both transacting parties to provide information to be audited. The auditor outputs “success” if all of the following audit conditions are meet:

Checking all transactions: Including commitment transactions and split transactions for off chain transactions.

Checking all audit trails:

$$Check if {\{ {τ}_{P}^{i} \}}_{i ∈ [ n ] , P ∈ \{ A , B \}} and {\{ {ϛ}_{P}^{i} , {r}_{P}^{i} \}}_{i ∈ [ n ] , P ∈ \{ A , B \}}$$

are correct.

Checking hash chains:

$$Check {H}_{0} ( {r}_{P}^{i} ) = {h}_{P}^{i} and {ϛ}_{P}^{i} = {H}_{0} ( {τ}_{P}^{i} ‖ {r}_{P}^{i} )$$

for 1≤i≤n.

Checking consistency between [symbol] and ηₙ: Compute the latest audit information [symbol] according to the provided information {γ.ctList,

$${\{ {η}_{i} , {ω}_{P} , {r}_{P}^{i} \}}_{i ∈ [ n ] , P ∈ \{ A , B \}} \} ,$$

and verify whether the hash value of [symbol] is equal to hash value of ηₙ that is included in the closing transaction [symbol] _{com}_{ₙ}.

Checking spending time of [symbol] _{com}_{ₙ}: If [symbol] _{com}_{ₙ} was spent on the blockchain, it was spent after 2Δ time since it was published on the blockchain.

Although the invention has been described above with reference to specific embodiments, the invention is not limited to the above embodiments and the specific configurations shown in the drawings. For example, some components shown can be combined with each other as one embodiment, and/or a component can be divided into several subcomponents, and/or any other known or available component can be added. The operation processes are also not limited to those shown in the examples. Those skilled in the art will appreciate that the invention can be implemented in other ways without departing from the substantive features of the invention. The present embodiments are therefore to be considered in all respects as illustrative and not restrictive. Other embodiments can be utilized and derived therefrom, such that structural and logical substitutions and changes can be made without departing from the scope of this disclosure. This Specification, therefore, is not to be taken in a limiting sense, along with the full range of equivalents to which such claims are entitled. This disclosure is intended to cover any and all adaptations and/or variations of various embodiments. Combinations of the above embodiments, and other embodiments not specifically described herein, will be apparent to those of ordinary skill in the art upon reviewing the above description.

What is claimed is:

1. A method for auditable off-chain transaction in block-chain network, comprising:
defining participants and their responsibilities, wherein the participants include counterparties requiring an off-chain transaction and auditors that audit transaction information of the off-chain transaction;
creating an off-chain payment channel for carrying out the off-chain transaction between the counterparties and initializing the off-chain payment channel by both of the counterparties;
after creating the off-chain payment channel, updating channel status during each transaction process; and
initiating an audit process to verify an integrity of a history of the off-chain transaction happened on the off-chain payment channel after the off-chain payment channel is closed;
wherein a hash chain linking current and previous transactions of the off-chain payment channel in a chronological order is established during the transaction processes, and an Accountable Assertions with Flexible Public Key (AAFPK) mechanism is used to bind fund and commitment information generated by both of the counterparties to a flexible public key through assertions, the hash chain is submitted to the auditors for verifying an order and a consistency of the off-chain transaction of the off-chain payment channel when the off-chain payment channel is closed, and the AAFPK mechanism binds any inconsistencies or differences of the off-chain transaction to a responsible party.

2. The method for auditable off-chain transaction in block-chain network of claim 1, further comprising:
triggering a punishment mechanism if a dishonest behavior is detected during the audit process, wherein the dishonest behavior includes publishing revoked transactions or tampering with transaction history or making contradictory statement.

3. The method for auditable off-chain transaction in block-chain network of claim 2, wherein the punishment mechanism comprises allowing the counterparty to obtain a deposit of a malicious party who fails to publish the transaction correctly.

4. The method for auditable off-chain transaction in block-chain network of claim 1, wherein
the step of creating an off-chain payment channel and initializing the off-chain payment channel by both of the counterparties by setting initial funds and submitting a transaction further comprises locally creating a funding transaction and a commitment transaction by both of the counterparties;
wherein the off-chain payment channel is successfully established when the funding transaction is published on the block-chain network, and the off-chain payment channel is ultimately closed when any commitment transaction is published to the block-chain network.

5. The method for auditable off-chain transaction in block-chain network of claim 1, wherein the establishment of the hash chain comprises:
after the off-chain payment channel is initialized and the fund and commitment information is bound to the flexible public key through assertions, calculating a hash value accordingly as a first hash value of the hash chain; and
after each update of the channel status, calculating a new hash value based on a current latest channel status and the harsh value of the previous transaction, and the new hash value is linked to the previous transaction.

6. The method for auditable off-chain transaction in block-chain network of claim 1, wherein the establishment of the hash chain comprises:
incorporating a timestamp of an on-chain transaction to accurately mark a timing of a commitment transaction created on the off-chain payment channel and to establish a correlation with the chronological order of on-chain transactions.

7. The method for auditable off-chain transaction in block-chain network of claim 1, wherein
the hash chain is established by Extractable Chameleon Hash with Flexible Public Key (ECHFPK), where a public key or secret key is transformable into a new representative of the same equivalence class, namely, the pair of old and new key are related through a hard relation R.

8. The method for auditable off-chain transaction in block-chain network of claim 1, wherein the AAFPK mechanism generates a key pair including a public key and a secret key, the key pair is transformable into a different representative key pair, and the AAFPK mechanism allows both of the counterparties to make multiple statements in the same context under different representative secret keys without exposing the secret key.

9. The method for auditable off-chain transaction in block-chain network of claim 7, wherein the ECHFPK comprises the following algorithms:
(cpk, csk)←Gench(1^{λ}): a setup algorithm takes a security parameter λ as an input and outputs a public key cpk and a secret key csk;
h←Ch(cpk, x; r): an evaluation algorithm generates a hash value h with the public key cpk, a message x, and a random r;
cpk′←ChgChCPK(cpk, ω): a public key transformation algorithm takes cpk of an equivalence class [cpk]_{R} and a public parameter ω as inputs, and outputs a different representative public key cpk′, where cpk′∈[cpk]_{R};
csk′←ChgChCSK(csk, ω): a secret key transformation algorithm takes a trapdoor csk and public parameter ω as inputs, and outputs a different representative secret key csk′, this algorithm is reversible that given csk′, it allows anyone to recover the secret key csk with the public parameter ω;
r₁←Col(csk′, x₀, r₀, x₁): a collision-finding algorithm takes a trapdoor csk′ and a triple x₀, r₀, x₁ as inputs, and outputs a value r₁ such that Ch(cpk′, x₀; r₀)=Ch(cpk′, x₁; r₁); and
csk′←ExtractCsk(cpk′, (x₀, r₀, x₁, r₁)): an extraction algorithm takes the different representative public key cpk′ and a 4-tuple (x₀, r₀, x₁, r₁) as inputs, and outputs csk′.

10. The method for auditable off-chain transaction in block-chain network of claim 9, wherein the extractable chameleon hash function satisfies the following three attributes:
collision-resistance: a PPT adversary A to find a collision without a trapdoor is negligible;
uniformity: given two messages x₀, and x₁, for a uniformly random value r₀, an output of Col is also a uniformly distributed random value;
extractability: given two pairs (x₀, r₀) and (x₁, r₁), where Ch(cpk′, x₀; r₀)=Ch(cpk′, x₁; r₁) and x₀≠x₁, the trapdoor csk′ can be extracted, the public and secret key transformation algorithms are instantiated according to the instantiation of extractable chameleon hash.

11. The method for auditable off-chain transaction in block-chain network of claim 1, wherein the AAFPK mechanism comprises the following algorithms:
(apk, ask, auxsk)←Gen(1^{λ}): a key generation algorithm inputs a security parameter λ, and outputs a public key apk, a secret key ask, an auxiliary secret information auxsk, for each public key, there is exactly one secret key;
ask′←ChgASK (ask, ω): a secret key transformation algorithm takes a representative secret key ask, and a public parameter ω as inputs, and outputs a different representative secret key ask′, the algorithm is reversible in that given ask′, it allows anyone to recover the secret key ask with the public ω;
apk′←ChgAPK(apk, ω): a public key transformation algorithm inputs a representative public key apk of equivalence class [apk]_{R}, and a public parameter ω, and outputs a different representative public key apk′∈[apk]_{R};
τ/⊥←Assert(ask′, auxsk, ct, st): an assertion algorithm takes a secret key ask′, an auxiliary secret information auxsk, a context ct, a statement st as inputs, and outputs an assertion τ (or ⊥ if the algorithm fails to execute);
1/0 ←Verify(apk′, ct, st, τ): a verification algorithm takes a public key apk′, a context ct, a statement st and an assertion τ as inputs, and outputs 1 if τ is a valid assertion;
ask′/⊥←Extract(apk′, ct, st₀, st₁, τ₀, τ₁): an extraction algorithm inputs a public key apk′, a context ct, two statements st₀, st₁, two assertions τ₀, τ₁, and outputs either ask′ or ⊥ to indicate failure.

12. The method for auditable off-chain transaction in block-chain network of claim 11, wherein the AAFPK mechanism is constructed by the following steps:
Key Generation: the key generation algorithm choosingL be a hash function: {0, 1}*→{1, . . . , [symbol] }, m and [symbol] are two positive integers that represent the branching and height of a tree, L(·) is modeled as a random oracle, H₀, H₂ be hash functions which are modeled as random oracles, H₁ be a collision-resistant hash function, and PRF be a pseudo-random function; then, generating the secret key ask:=csk, auxiliary secret information auxsk:=κ, where (cpk, csk)←ECHFPK.GenCh(1^{λ}), κ∈{0, 1}^{λ} is a key for the PRF, setting the public key as apk:=(cpk, z, L, H₀, H₁, H₂), where
$$z := {H}_{0} ( {y}_{1}^{1} , … , {y}_{m}^{1} ) , {y}_{i}^{1} := Ch ( {PRF}_{κ} ( id , i , 0 ) ;$$
PRF_{κ}(id, i, 1)), i∈[m], and id is an identifier for the position of the root node;
Secret Key Transformation: in this algorithm, the secret key is represented as ask and initially set as csk, then converting ask into a new key ask′ using the ChgASK(ask, ω) function, ask′ and ask belong to the same equivalence class, this function effectively converts the secret key into another secret key within the same class, represented as ask′:=ECHFPK.ChgChCSK(csk, ω), and ω stands for a specific public parameter chosen for this operation, this transformation allows the original secret key ask, to be retrieved when given csk and ω;
Public Key Transformation: this algorithm changes the public key apk:=(cpk, z, L, H₀, H₁, H₂) into an updated public key apk′:=(cpk′, z), where cpk′:=ECHFPK.ChgChCPK(cpk, ω) and ω refers to a chosen public parameter, this transformation allows the original secret key ask, to be retrieved when given csk and ω;
Assertion: the assertion algorithm takes (ask′, auxsk, ct, st) as inputs, then computes the assertion path { [symbol] , [symbol] , . . . , Y₁, a₁} from the leaf node [symbol] to the root node Y₁, [symbol] stores the number L(ct) and each node Yⱼ contains m entries
$${Y}_{j} := \{ {y}_{1}^{j} , … , {y}_{m}^{1} \} ,$$
j∈[m] at positions aⱼ∈{1, . . . , m}, to assert a statement st in the context ct which is stored in [symbol] , the assertion algorithm computes
$${r}_{{a}_{ℓ}}^{′ℓ} := Col ( {csk}^{′} , {x}_{{a}_{ℓ}}^{ℓ} , {r}_{{a}_{ℓ}}^{ℓ} , {H}_{1} ( s t ) ) , ( {x}_{{a}_{ℓ}}^{ℓ} , {r}_{{a}_{ℓ}}^{ℓ} )$$
refer to the values that were set when the tree was initially generated, the calculation formula for the position of this entry is
$${y}_{{a}_{ℓ}}^{ℓ} = {H}_{2} ( Ch ( {cpk}^{′} , {H}_{1} ( st ) ; {r}_{{a}_{ℓ}}^{′ℓ} ) , {r}_{{a}_{ℓ}}^{′ℓ} ) = {H}_{2} ( Ch ( {cpk}^{′} , {x}_{{a}_{ℓ}}^{ℓ} ; {r}_{{a}_{ℓ}}^{′ℓ} ) ,$$
then the algorithm calculates other entries of [symbol] as:
$${y}_{i}^{ℓ} := Ch ( {cpk}^{′} , {x}_{i}^{ℓ} ; {r}_{i}^{′ℓ} ) ,$$
where i∈[m] \ [symbol] ; it stores the entries
$$\{ {y}_{1}^{ℓ} , … , {y}_{m}^{ℓ} \}$$
to [symbol] , and lets
$${z}_{ℓ} := {H}_{0} ( {y}_{1}^{ℓ} , … , {y}_{m}^{ℓ} ) and {f}_{ℓ} := ( {y}_{1}^{ℓ} , … , {y}_{{a}_{ℓ - 1}}^{ℓ} , {y}_{{a}_{ℓ + 1}}^{ℓ} , … , {y}_{m}^{ℓ} ) ;$$
similarly, the algorithm calculates other nodes ( [symbol] , [symbol] , . . . , Y₁, a₁) as in the computation of ( [symbol] , [symbol] ); with these information, the assertion
$$τ := ( ( {r}_{{a}_{ℓ}}^{′ℓ} , {f}_{ℓ} , {a}_{ℓ} ) , … , ( {r}_{1}^{′1} , {f}_{1} , {a}_{1} ) ,$$
where
$${f}_{ϵ} := ( {y}_{1}^{ϵ} , … , {y}_{{a}_{ℓ - {1}^{J}}}^{ϵ} , {y}_{{a}_{ℓ + 1}}^{ϵ} , … , {y}_{m}^{ϵ} ) ;$$
Verification: this algorithm takes (apk′, ct, st, τ) as inputs, and parses apk′ as (cpk′, z) and τ as
$$( ( {r}_{{a}_{ℓ}}^{′ℓ} , {f}_{ℓ} , {a}_{ℓ} ) , … , ( {r}_{1}^{′1} , {f}_{1} , {a}_{1} ) ) ;$$
then it reconstructs the path from the leaf node Yₗ to the root Y₁, where
$${y}_{l} := ( {y}_{1}^{1} , … , {y}_{m}^{1} ) ;$$
if the constructed root
$$H ( {y}_{1}^{1} , … , {y}_{m}^{1} )$$
is equal to z, it outputs 1; otherwise, it outputs 0;
Extraction: this algorithm takes (apk′, ct, st₀, st₁, τ₀, τ₁) as inputs and reconstructs the path from the leaf node to the root node for both (ct, st₀, τ₀) and (ct, st₁, τ₁); during the reconstruction, there will exist a node that forms a collusion in ECHFPK; that is, there exist values (x₀, r₀) and (x₁, r₁) that enables ECHFPK.Ch(cpk′, x₀; r₀)=ECHFPK.Ch(cpk′, x₁; r₁); according to the extraction algorithm of ECHFPK, the secret key cpk′ can be extracted as csk′←ECHFPK.ExtractCsk(cpk′, x₀, r₀, x₁, r₁); if no collusion is found, the extraction algorithm outputs 1.

13. The method for auditable off-chain transaction in block-chain network of claim 2, wherein the step of creating an off-chain payment channel for carrying out the off-chain transaction between the counterparties and initializing the off-chain payment channel by both of the counterparties comprises:
creating a payment channel involves three key steps for the transacting parties, generating the funding transaction [symbol] _{fund}, creating the initial commitment transaction [symbol] _{com}_{₀}, and forming the initial split transaction [symbol] ₛₚₗ_{₀};
wherein the counterparties include users A and B start by locally creating the funding transaction [ [symbol] _{fund}] and the commitment transaction [ [symbol] _{com}_{₀}]; to do this, A generates (apk_{A}, ask_{A}, auxsk_{A}) and B generates (apk_{B}, ask_{B}, auxsk_{B}), using function \tilde{Σ}.Gen with a security parameter λ, auxsk:=H₀(ask); the secret keys ask_{A} and ask_{B} are termed colluding secrets to ensure that any attempt by A and B to alter the history of off-chain transactions in γ can be penalized; then A and B exchange their public keys, jointly build fund transactions this fund transactions contains public key pairs ξ₀=(apk_{A}, ask_{B}) and initial information of audit trail h₀=H₁(ξ₀); these pieces of information are included in non consumable outputs, such as Bitcoin's OP-RETURN; and then each party generate their accountable assertions
$${τ}_{A}^{0} and {τ}_{B}^{0} ,$$
where
$${τ}_{A}^{0} = \tilde{\sum } \cdot Assert ( {ask}_{A} , {auxsk}_{A} , {H}_{1} ( 0 , [ {𝒯}_{fund} ] , [ {𝒯}_{{com}_{0}} ] ) ,$$
and similarly party B computes
$${τ}_{B}^{0} ;$$
to ensure the validity of assertions, both parties exchange assertions and use the verification algorithm \tilde{Σ}. Verify to validate each other's assertions, if the verification is successful, A and B generate proof
$${Ϛ}_{A}^{0} and {Ϛ}_{B}^{0} ;$$
this proof associates each party's private revocation key (r) with the other party's assertion (τ) using a hash function,
$${Ϛ}_{A}^{0} = {H}_{0} ( {τ}_{B}^{0} ‖ {r}_{A}^{0} ) , {Ϛ}_{B}^{0} = {H}_{0} ( {τ}_{A}^{0} ‖ {r}_{B}^{0} ) ;$$
this mechanism also incorporates the timestamp of on-chain transactions to mark the commitment transactions' timing accurately; the audit trail from the first commitment transaction is captured in the format:
$${η}_{0} := ( {τ}_{A}^{0} , {τ}_{B}^{0} , {Ϛ}_{A}^{0} , {Ϛ}_{B}^{0} , [ {𝒯}_{fund} ] , [ {𝒯}_{{com}_{0}} ] , n ) , where {Ϛ}_{A}^{0} := {H}_{0} ( {τ}_{B}^{0} ‖ {r}_{A}^{0} ) , {Ϛ}_{B}^{0} = {H}_{0} ( {τ}_{A}^{0} ‖ {r}_{B}^{0} ) ;$$
once transacting parties generate the complete commitment transaction, they can exchange the (pre-)signature [symbol] ₛₚₗ_{₀}, [symbol] _{com}_{₀}, and [symbol] _{fund}, when [symbol] _{fund} is published on the blockchain, an auditable payment channel γ is successfully established.

14. The method for auditable off-chain transaction in block-chain network of claim 13, wherein in the step of updating channel status during each transaction process, the counterparties pay for each other by updating the state of the off-chain channel, they collaboratively update the state of γ from γ.cash:= (x_{A}, x_{B}) to γ. [symbol] :=( [symbol] , [symbol] ); this process involves several key steps: Invalidation of the Old Commitment Transaction and Generation of New Transactions; each off-chain transaction [ [symbol] _{com}_{ₙ}] is constructed to distribute the total coins (x_{A}+x_{B}) in γ based on the latest agreed-upon balances; if either party releases [ [symbol] _{com}_{ₙ}] to the blockchain, the following conditions will be activated: (1) Colluding condition: (x_{A}+x_{B}) can be spent by a blockchain on-chain transaction that is verifiable w.r.t. X_{A} and X_{B} at any time after [ [symbol] _{com}_{ₙ}] was published on blockchains; if there are forged or unverified off chain transaction records, all funds in the channel can be used by the other party; (2) Publishing condition: (x_{A}+x_{B}) can be spent by either party with a time lock Δ if [ [symbol] _{com}_{ₙ}] was revoked; it allows funds to be used by both parties after the designated time lock Δ expires; (3) Finalizing condition: (x_{A}+x_{B}) is spent by A and B for finalizing the channel state of γ with a time lock 2Δ if [ [symbol] _{com}_{ₙ}] has not been revoked; both parties collaborate to ultimately close the channel state, and the time lock of Δ is usually twice the release condition, used to provide a penalty time window;
further, a participant (e.g., A) selects a public parameter ω_{A}∈Z_{q}* and modifies their secret key to
$${ask}_{A}^{n} := \sum \cdot ChASK ( {ask}_{A} , n \cdot {ω}_{A} ) := {ask}_{A} ⊕ n \cdot {ω}_{A} ,$$
the calculation method for public parameters is ω_{A}:=H₀( [symbol] _{fund}); when the n-th off-chain transaction is created in γ, users A and B exchange their accountable assertions
$${τ}_{A}^{n} , {τ}_{B}^{n} ,$$
where
$${τ}_{A}^{n} ← \tilde{\sum } \cdot Assert ( {ask}_{A} , {auxsk}_{A} , ct , {st}_{n} ) and {τ}_{B}^{n}$$
is the same; after exchange their accountable assertions, they embed the hash chain hₙ=Hash₁(hₙ₋₁∥ξₙ) in [ [symbol] _{com}_{ₙ}]; before committing it in γ; upon receiving assertion
$${τ}_{A}^{n} ,$$
party B first computes a new representative public key
$${apk}_{A}^{n} = \tilde{\sum } \cdot ChAPK ( {apk}_{A} , n ⊙ {ω}_{A} ) := {apk}_{A} , n ⊙ {ω}_{A}$$
and then verifies
$${τ}_{A}^{n}$$
through using
$$\tilde{\sum } \cdot Verify ( {apk}_{A}^{n} , ct , {st}_{n} , {τ}_{A}^{n} ) ,$$
if the verification is successful, B generates an audit certificate for A:
$${Ϛ}_{B}^{n} := {H}_{0} ( {τ}_{A}^{0} ‖ {r}_{B}^{0} ) , {r}_{B}^{n}$$
is the revocation key of B; then they record the audit trail ηₙ and generate as in Equation (1); the timestamp value is set to the earliest timestamp in the latest block; finally, both parties sign a complete commitment transaction and split transaction.

15. The method for auditable off-chain transaction in block-chain network of claim 14, wherein the punishment mechanism is triggered in the following two situations: (i) publish old commitment transactions; when A publishes a revoked old commitment transaction, the other party B can use the pre signature and full signature of the commitment transaction, and calculate A's secret witness yₙ through the extractability of the adapter signature; (ii) redeclaration; when A generates two statements using the same representative private key, the other party B can use the key extraction algorithm. \tilde{Σ}. Extract the secret private key ask_{A} of A.

16. The method for auditable off-chain transaction in block-chain network of claim 15, wherein the audit process is performed by the auditor who requires both of the counterparties to provide information to be audited; the auditor outputs “success” if all of the following audit conditions are meet:
Checking all transactions: Including commitment transactions and split transactions for off chain transactions;
Checking all audit trails: Check if
$${\{ {τ}_{P}^{i} \}}_{i ∈ [ n ] , P ∈ \{ A , B \}} and {\{ {Ϛ}_{P}^{i} , {r}_{P}^{i} \}}_{i ∈ [ n ] , P ∈ \{ A , B \}}$$
are correct;
Checking hash chains: Check
$${H}_{0} ( {r}_{P}^{i} ) = {h}_{P}^{i} and {Ϛ}_{P}^{i} = {H}_{0} ( {τ}_{P}^{i} ‖ {r}_{P}^{i} )$$
for 1≤i≤n;
Checking consistency between [symbol] and ηₙ: Compute the latest audit information [symbol] according to the provided information {γ.ctList, {ηᵢ, ω_{P},
$${r}_{P}^{i}$$
}_{i∈[n],P∈{A,B}}}, and verify whether the hash value of [symbol] is equal to hash value of ηₙ that is included in the closing transaction [symbol] _{com}_{ₙ};
Checking spending time of [symbol] _{com}_{ₙ}: If [symbol] _{com}_{ₙ} was spent on the blockchain, it was spent after 2Δ time since it was published on the blockchain.

17. A system for implementing the method of claim 1, comprising:
two counterparties for creating, updating, and closing an off-chain payment channel, wherein the two counterparties transact with each other directly through the off-chain payment channel;
an auditor for verifying the integrity and consistency of transactions on the off- chain payment channel and punishing dishonest behavior; and
a blockchain network for recording and validating transactions happened on the off-chain payment channel.

18. A computer-readable storage medium storing a computer program that, when executed, performs the method of claim 1.
